(19) United States
(12) Patent Application Publication
(10) Pub. No.: US 2015/0169441 A1
(43) Pub. Date: Jun. 18, 2015

(54) METHOD OF MANAGING DATA OF AN ELECTRONIC CONTROL MODULE OF A MACHINE

(71) Applicant: Caterpillar Inc., Peoria, IL (US)

(72) Inventors: Praveen K. Cheppali, Cuddapah (IN); Eric F. Lee, Peoria, IL (US)

(73) Assignee: Caterpillar Inc., Peoria, IL (US)

(21) Appl. No.: 14/630,646

(22) Filed: Feb. 25, 2015

(51) Int. Cl. G06F 12/02

(52) U.S. Cl. CPC G06F 12/0246; G06F 2212/7209

(57) ABSTRACT

The present disclosure is related to a method of managing data of an ECM associated with an engine. The ECM includes a microprocessor, a BBRAM and an EEPROM communicably coupled to the microprocessor. The method includes rewriting a data stored in a BBRAM of the ECM by copying data from the BBRAM to an EEPROM of the ECM if a BBRAM data is determined as valid and an EEPROM data is determined as not valid. The method includes determining a difference between the BBRAM data and the EEPROM data if the BBRAM data is determined as not valid and the EEPROM data is determined as valid. The method includes retaining the BBRAM data if the determined difference is lesser than the predetermined value, and rewriting the BBRAM data by copying the EEPROM data to the BBRAM if the determined difference is higher than or equal to the predetermined value.

### TECHNICAL FIELD

The present disclosure relates to a method of managing data of an electronic control module (ECM) of a machine, and more particularly to a method of managing data of an electronic control module (ECM) associated with an engine of the machine.

### BACKGROUND

Machines such as, a mining truck generally includes an Electronic Control Module (ECM) to control and monitor various functions of the machine. The ECM may receive various parameters associated with an engine and stores the parameter data in a memory associated with the ECM. Moreover, a performance characteristic of the engine may be recorded for long durations and stored in a volatile memory of the ECM. Further, a backup for the data may be stored periodically in a non-volatile memory of the ECM. Typically, the volatile memory of the ECM may be powered by a battery unit.

In some cases, a failure of the battery unit may corrupt the data stored in the volatile memory. In other cases, if the battery which powers the ECM is shut down before the engine, there may not be a complete backup of the data in the non-volatile memory. Hence, the parameter data provided to the customers may be invalid. Further, if any of the data related to the engine parameters is lost or invalid, an engine performance estimation based on these parameters may not be accurate.

For reference, J.P Patent 2009/229080 is related to an operation management system for a machine. The system includes a volatile memory for updating and recording time in a predetermined unit. The system also records the time that is recorded in the volatile memory and the drive information of an operation section of the working machine in a drive information recording section in connection with the volatile memory. The operation management system is further provided with a nonvolatile memory for updating and recording time in a unit larger than that of the volatile memory. When the time recorded in the volatile memory becomes inconsistent with the time recorded in the nonvolatile memory, the record in the nonvolatile memory is loaded into the volatile memory.

### SUMMARY OF THE DISCLOSURE

In one aspect of the present disclosure a method of managing data of an electronic control module associated with an engine of a machine is provided. The ECM includes a microprocessor, a Battery Backup RAM (BBRAM), a battery, and an Electrically Erasable Programmable Read Only Memory (EEPROM). The Battery Backup RAM (BBRAM) is communicably coupled to the microprocessor and is configured to store data corresponding to at least one parameter of the engine. The battery is configured to power the BBRAM. The EEPROM is communicably coupled to the microprocessor and is configured to store plurality of copies of data corresponding to the parameter.

The method includes determining the percentage of unused locations of the BBRAM having a binary value different from a default value on activation of the ECM. The method further includes determining that the stored data is valid if the determined percentage is lesser than or equal to a threshold percentage and invalid if the determined percentage is higher than threshold percentage. The method includes determining that the data stored in the EEPROM is invalid if the data stored in the EEPROM is zero or if the plurality of copies of data corresponding to the parameter are different from each other. The method also includes determining that the data stored in the EEPROM is valid if at least two copies of the plurality of copies of data corresponding to the parameter are equal to each other. The method further includes rewriting the data stored in the BBRAM by copying data from the BBRAM to the EEPROM if the data stored in the BBRAM is determined as valid and the data stored in the EEPROM is determined as not invalid.

The method also includes determining a difference between the data corresponding to the parameter stored in the BBRAM and the data corresponding to the parameter stored in the EEPROM if the data stored in the BBRAM is determined as invalid and the data stored in the EEPROM is determined as valid. The method includes comparing the difference with a predetermined value, and retaining the data stored in the BBRAM if the determined difference is less than the predetermined value. The method also includes rewriting the data stored in the BBRAM by copying the data stored in the EEPROM to the BBRAM if the determined difference is higher than or equal to the predetermined value. The method further includes copying periodically data stored in the BBRAM to the EEPROM till deactivation of the ECM.

Other features and aspects of this disclosure will be apparent from the following description and the accompanying drawings.

### BRIEF DESCRIPTION OF THE DRAWINGS

FIG. 1 illustrates a perspective view of an exemplary machine;

FIG. 2 illustrates a block diagram of an electronic control module (ECM) of the machine, according to an embodiment of the present disclosure;

FIG. 3 illustrates a flowchart for managing data of the ECM, according to an embodiment of the present disclosure; and

FIGS. 4 and 5 illustrate a method of managing a data of the ECM, according to an embodiment of the present disclosure.

### DETAILED DESCRIPTION

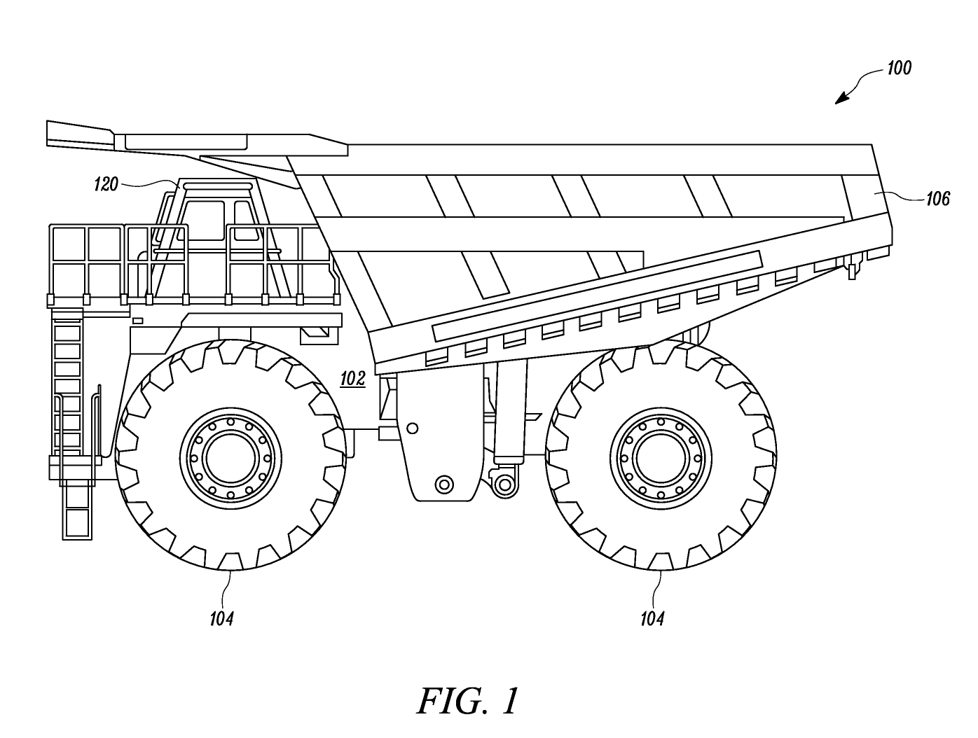

Reference will now be made in detail to specific embodiments or features, examples of which are illustrated in the accompanying drawings. Wherever possible, corresponding or similar reference numbers will be used throughout the drawings to refer to the same or corresponding parts. Referring to FIG. 1, an exemplary machine 100 is illustrated. More specifically, the machine 100 is a dump truck. In other examples, the machine 100 may be associated with an industry, such as construction, mining, forestry, agriculture, waste management, material handling, transportation, and the like. Accordingly, the machine 100 may be an electric generator, a mining truck, an excavator, a loader, and the like.

The machine 100 includes a frame 102 for supporting various components of the machine 100. The frame 102 is supported on a set of ground engaging members 104. The ground engaging members 104 may enable steering and maneuvering the machine 100, and for propelling the machine 100 in forward and reverse directions. In the illustrated embodiment, the ground engaging members 104 are wheels. However, in an alternative embodiment, the ground engaging members 104 may be track assemblies.

The machine 100 also includes a payload carrier 106. The payload carrier 106 may be pivotally coupled to the machine 100. In various other examples, the machine 100 may include work tools, such as excavating buckets, for performing various operations. The machine 100 may further include an operator station or a cab 120 supported on the frame 102. The operator cab 120 may include input devices and operator interfaces for receiving inputs for operating the machine 100.

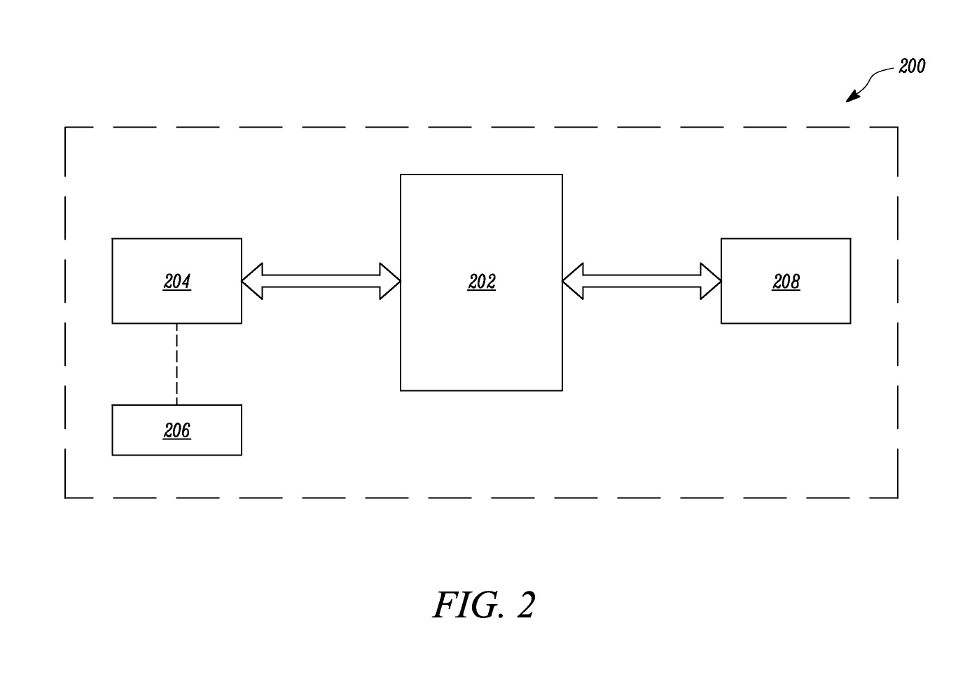

The machine 100 may also include a power source, such as an engine (not shown). The engine may be an internal combustion engine, which may power various components of the machine 100 such as the ground engaging members 104, the payload carrier 106, and the like. The machine 100 may further include an electronic control module (ECM) 200 (shown in FIG. 2) associated with the engine.

Referring to FIG. 2 a block diagram of the ECM 200 is illustrated, according to an embodiment of the present disclosure. The ECM 200 electrically connects to various control elements of the engine as well as various input devices for commanding the operation of the engine and monitoring its performance. The ECM may also be configured to control various operations of the machine 100.

The ECM 200 includes a microprocessor 202 for executing programs in order to control various functions associated with the engine and/or the machine 100. Although the microprocessor 202 is shown, it may be contemplated that other electronic components such as a microcontroller, an Application Specific Integrated Circuit (ASIC) chip, or any other integrated circuit device may also be used.

The microprocessor 202 may be configured to determine parameters related the engine such as, a total fuel, a total idle fuel, engine revolutions, a total operating time and the like. Moreover, the ECM 200 may be communicably coupled to various sensors (not shown) configured to detect information related to the parameters of the engine. For example, the information may be a fuel injection duration, an engine speed, a rate of fuel delivery to the engine, a ratio of air to fuel used in the engine, a fuel temperature, an oil pressure, an oil temperature, an exhaust temperature, and the like. The microprocessor 202 may be configured to calculate the parameters over a period of time based on the information.

The ECM 200 includes a Battery Backup Random Access Memory (BBRAM) 204 that is communicably coupled to the microprocessor 202. The BBRAM 204 is configured to store data (hereinafter referred to as “the BBRAM data”) corresponding to at least one of the parameters of the engine. Further, the BBRAM 204 may be configured to store the BBRAM data after every predetermined time interval. In an example, the total fuel may be determined for every 30 milliseconds and subsequently stored in the BBRAM 204.

The BBRAM 204 may also include unused locations not having any stored data. Each of the unused locations may be associated with a default value. The default value may be one of a binary value, i.e., 0 or 1. The ECM 200 further includes a battery 206 configured to power the BBRAM 204. The battery 206 may include a set of individual electrochemical cells. In an example, the battery 206 may be a lithium battery. In other examples, the battery 206 may be a lead-acid, a nickel-cadmium battery, and the like.

The ECM 200 also includes an Electrically Erasable Programmable Read Only memory (EEPROM) 208 communicably coupled to the microprocessor 202. The EEPROM 208 is configured to store multiple copies of the BBRAM data corresponding to the parameter. Further, the EEPROM 208 is configured to periodically store multiple copies of the BBRAM data. For example, the EEPROM 208 stores a backup of the BBRAM data after an hour is elapsed until the ECM 100 is deactivated. Additionally, the EEPROM 208 is also configured to store the EEPROM data when the ECM 200 is started or powered on. The EEPROM 208 may be powered by a main battery (not shown) associated with the engine.

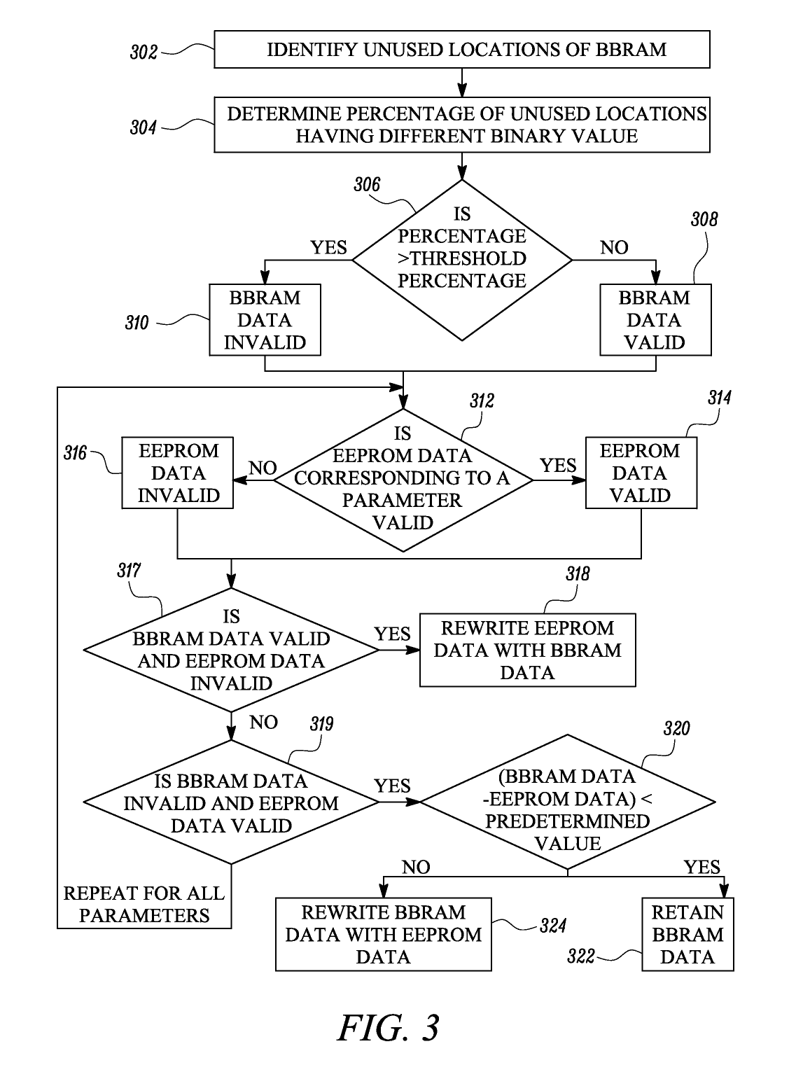

Referring to FIG. 3, a flowchart for managing the data of the ECM 200 is illustrated, according to an embodiment of the present disclosure. In an embodiment, the flowchart may be executed on activation of the ECM 200. Additionally or optionally, the flowchart may be executed upon detecting a failure of the battery 206.

At step 302, the unused locations of the BBRAM 204 are identified. The microprocessor 202 of the ECM 200 may be configured to identify the unused locations of the BBRAM 204. At step 304, a percentage of unused locations of the BBRAM 204 having a binary value different from the default value set for the unused locations is determined. The microprocessor 202 may be configured to read data in the unused locations. Further, the microprocessor 202 may be configured to count a number of unused locations having the binary value different from the default value. For example, the BBRAM 204 may include 120 unused locations for which a default value may be set as a binary value 0. However, the binary value for some of the unused locations for example, 30 unused locations may change to 1. In such a case, the microprocessor 202 may determine that the percentage of unused locations having the binary value 1 is 25.

At step 306, the validity of the BBRAM data is checked. Specifically, at step 306, the microprocessor 202 may check if the percentage is less than or equal to a threshold percentage. In an example, the threshold percentage may be 25. At step 308, the microprocessor 202 may determine the BBRAM data as valid upon determining that the percentage is less than or equal to the threshold percentage. However, if at step 306, the microprocessor 202 determines that the percentage is greater than the threshold percentage, the microprocessor 202 may determine that the BBRAM data is invalid at step 310.

The microprocessor 202 may pass the control to step 312 after checking the validity of the BBRAM data. At step 312, the microprocessor 202 may check for validity of the EEPROM data corresponding to one of the parameters of the engine. In an embodiment, the microprocessor 202 may determine that the EEPROM data is valid if at least two copies of the multiple copies of the data corresponding to the parameter are equal to each other. Moreover, the microprocessor 202 may return the control to step 314 upon determining that the EEPOM data is valid.

However, if at step 312, the microprocessor 202 determines that the data stored in the EEPROM 208 is zero or if the multiple copies of the data corresponding to the parameter are different from each other, the microprocessor 202 may determine the EEPROM data as invalid. Moreover, the microprocessor 202 may return the control to step 316 upon determining that the EEPROM data is invalid.

Further, the microprocessor 202 may pass the control to step 317 after determining the validity of the EEPROM data. The microprocessor 202 may pass the control to step 318 from step 317 if the BBRAM data is determined as valid and the EEPROM data is determined as invalid. At step 318, the microprocessor 202 may rewrite the EEPROM data with the BBRAM data.

However, if at step 317, the microprocessor 202 determines that the BBRAM data is invalid, the microprocessor 202 may pass the control to step 319. Further, the microprocessor 202 may pass the control to step 320 from step 319, if the EEPROM data is determined as valid. At step 320, the microprocessor 202 may check if a difference between the BBRAM data and the EEPROM data corresponding to the parameter is less than a predetermined value. The predetermined value for each of the parameters may be chosen based on an engine operation over a specified time duration. The specified time duration may correspond to a periodicity at which the BBRAM data is copied to the EEPROM 208. In an example, the specified time duration may be one hour. In such a case, the predetermined value corresponding to the engine revolutions parameter may be an estimated number of engine revolutions per hour.

Further, the microprocessor 202 may pass the control to step 322 upon determining that the difference is less than the predetermined value. At step 322, the microprocessor 202 may retain the data stored in the BBRAM 204. However, if the microprocessor 202 determines that the difference is greater than or equal to the predetermined value, the control may pass to step 324. At step 324, the microprocessor 202 may rewrite the BBRAM data with the EEPROM data.

Moreover, the microprocessor 202 may return the control from step 319 to step 312 to check for validity of the EEPROM data corresponding to another parameter of the engine. The microprocessor 202 may subsequently execute step 412 to determine the validity of the EEPROM data corresponding to each of the parameters stored in the BBRAM 204. Further, at step 418, the microprocessor 202 may rewrite the EEPROM data with the BBRAM data if the BBRAM data is determined as valid and the EEPROM data is determined as invalid. Moreover, at step 320, the difference between the EEPROM data and the BBRAM data for each parameter may be compared with the corresponding predetermined value. Accordingly, the microprocessor 202 may determine either to retain or rewrite the BBRAM data corresponding to each of the parameters.

The ECM 200 may execute the flowchart illustrated in FIG. 3 after activation of the ECM 200. Further, the BBRAM data may be periodically copied to the EEPROM 208 till the deactivation of the ECM 200. For example, after every one hour, the BBRAM data may be copied to the EEPROM 208 and stored as multiple copies.

### INDUSTRIAL APPLICABILITY

The present disclosure relates to the ECM 200 that is configured to implement one or more control logics of the flowchart illustrated in FIG. 3. Accordingly, the ECM 200 may determine if the BBRAM data is valid or invalid. Further, the ECM 200 may also be configured to determine if the EEPROM data is valid or invalid. Moreover, the ECM 200 may be configured to rewrite the BBRAM data with the EEPROM data if the BBRAM data is invalid and the EEPROM data is valid. Further, the ECM 200 may be configured to rewrite the EEPROM data with the BBRAM data if the BBRAM data is valid and the EEPROM data is invalid.

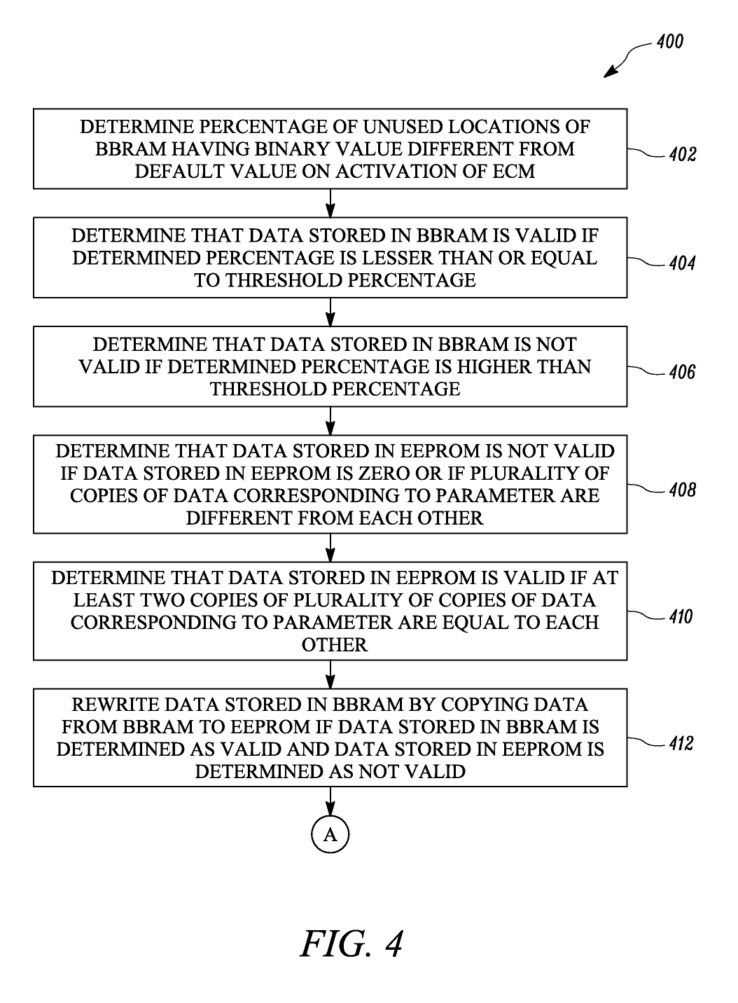

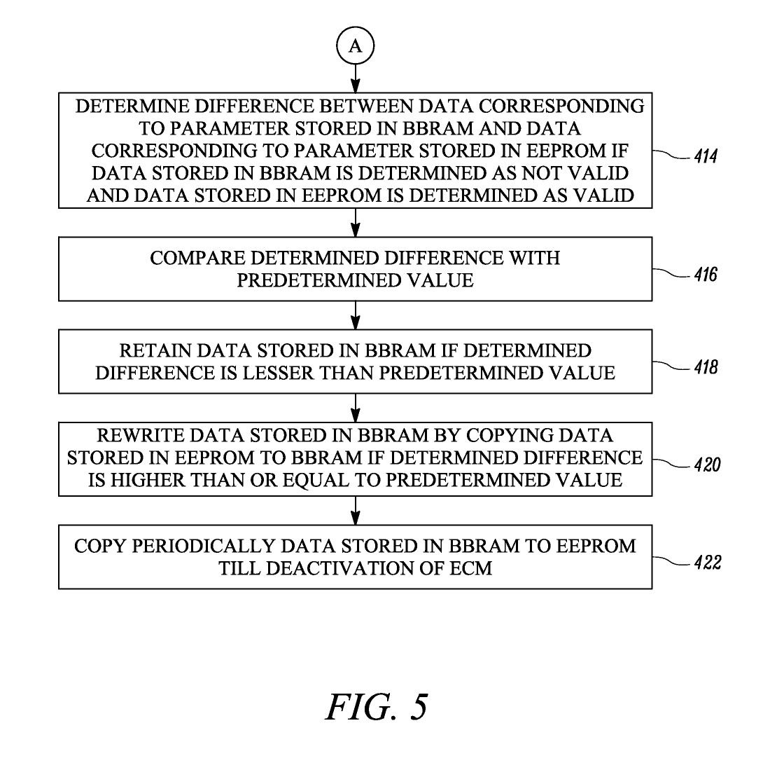

Referring to FIGS. 4 and 5, a method 400 of managing data in the ECM 200 is illustrated. In an embodiment, the method 400 may be implemented by various components of the ECM 200, such as the microprocessor 202, the BBRAM 204 and the EEPROM 208. At step 402, the method 400 includes determining the percentage of the unused locations of the BBRAM 204 having a binary value different from the default value on activation of the ECM 200. At step 404, the method 400 includes determining that the BBRAM data is valid if the determined percentage is lesser than or equal to the threshold percentage. At step 406, the method 400 includes determining that the BBRAM data is invalid if the determined percentage is higher than the threshold percentage.

At step 408, the method 400 includes determining that the EEPROM data is invalid if the data stored in the EEPROM 208 is zero or if the plurality of copies of data corresponding to the parameter are different from each other. At step 410, the method 400 includes determining that the EEPROM data is valid if at least two copies of the plurality of copies of data corresponding to the parameter are equal to each other. At step 412, the method 400 includes rewriting the BBRAM data by copying the BBRAM data to the EEPROM 208 if the BBRAM data is determined as valid and the data stored in the EEPROM 208 is determined as invalid.

In some cases, where the ECM 200 is turned off before the engine is shut down, the BBRAM data over a certain period of time is not backed up in the EEPROM. As such, there may be the difference between the BBRAM data and the EEPROM data corresponding to the one or more parameters. The method 400 of the present disclosure includes checking the BBRAM data with the EEPROM data before rewriting the BBRAM data with the EEPROM data.

At step 414, the method 400 includes determining the difference between the data corresponding to the parameter stored in the BBRAM 204 and the data corresponding to the parameter stored in the EEPROM 208 if the data stored in the BBRAM 204 is determined as not valid and the data stored in the EEPROM 208 is determined as valid. At step 416, the method 400 includes comparing the determined difference with the predetermined value.

At step 418, the method 400 includes retaining the BBRAM data if the determined difference is lesser than the predetermined value. At step 420, the method 400 includes rewriting the data stored in the BBRAM 204 by copying the EEPROM data to the BBRAM if the determined difference is higher than or equal to the predetermined value. Therefore, as described in step 416 above, the method 400 enables rewrite of the BBRAM only after performing an additional check. Consequently, any loss of data due to improper shutdown of the ECM 200 may be minimized. The above described method 400 of managing data within the ECM 200 may be implemented for all the parameters. At step 422, the method 400 includes copying periodically the BBRAM data to the EEPROM 208 till deactivation of the ECM 200.

In an embodiment, one or more of the steps of the method 400 may be implemented according to the logic illustrated in the flowchart of FIG. 3. With such an implementation, an accuracy of data corresponding to the parameters of the engine may be improved. As such, a performance of the engine, a warranty claim or a resale value of the machine 100 may be accurately estimated.

Additionally, such an implementation may reduce a data rewrite cycles of the EEPROM 208 compared to the BBRAM 204. Further, a time period for copying the BBRAM data to the EEPROM 208 may be suitably chosen. As such, a life of the EEPROM 208 may be increased, thereby increasing a life of the ECM 200.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of managing data of a Electronic Control Module (ECM) associated with an engine of a machine, the ECM having a microprocessor, a Battery Backup RAM (BBRAM) communicably coupled to the microprocessor and configured to store data corresponding to at least one parameter of the engine, a battery configured to power the BBRAM, and an Electrically Erasable Programmable Read Only Memory (EEPROM) communicably coupled to the microprocessor and configured to store a plurality of copies of data corresponding to the parameter, the method comprises:
determining a percentage of unused locations of the BBRAM having a binary value different from a default value on activation of the ECM;
determining that the data stored in the BBRAM is valid if the determined percentage is lesser than or equal to a threshold percentage;
determining that the data stored in the BBRAM is not valid if the determined percentage is higher than the threshold percentage;
determining that data stored in the EEPROM is not valid if the data stored in the EEPROM is zero or if the plurality of copies of data corresponding to the parameter are different from each other;
determining that the data stored in the EEPROM is valid if at least two copies of the plurality of copies of data corresponding to the parameter are equal to each other;
rewriting the data stored in the BBRAM by copying data from the BBRAM to the EEPROM if the data stored in the BBRAM is determined as valid and the data stored in the EEPROM is determined as not valid;
determining a difference between the data corresponding to the parameter stored in the BBRAM and the data corresponding to the parameter stored in the EEPROM if the data stored in the BBRAM is determined as not valid and the data stored in the EEPROM is determined as valid;
comparing the determined difference with a predetermined value;
retaining the data stored in the BBRAM if the determined difference is lesser than the predetermined value;
rewriting the data stored in the BBRAM by copying the data stored in the EEPROM to the BBRAM if the determined difference is higher than or equal to the predetermined value; and
copying periodically data stored in the BBRAM to the EEPROM till deactivation of the ECM.
